(19) United States
(12) Patent Application Publication
(10) Pub. No.: US 2015/0263898 A1
(43) Pub. Date: Sep. 17, 2015

(54) BLACK BOX DEVICE AND METHOD FOR SUPPORTING RESTORATION OF A SMART GRID SYSTEM

(71) Applicant: ELECTRONICS AND TELECOMMUNICATIONS RESEARCH INSTITUTE, Daejeon-city (KR)

(72) Inventors: In-Cheol Shin, Daejeon (KR); Sin-Kyu Kim, Daejeon (KR); Jung-Taek Seo, Daejeon (KR)

(21) Appl. No.: 14/434,467

(22) PCT Filed: Oct. 2, 2013
(86) PCT No.: PCT/KR2013/008833

§ 371 Date: Apr. 9, 2015

(30) Foreign Application Priority Data
Oct. 12, 2012 (KR) 10-2012-0113693
Aug. 13, 2013 (KR) 10-2013-0095711

(51) Int. Cl. H04L 12/24; H04L 29/08

(52) U.S. Cl. CPC H04L 41/0816; H04L 67/10

(57) ABSTRACT

A black box apparatus and apparatus for supporting the reconfiguration of a smart grid system. The apparatus includes a monitoring unit, an information collection unit, and an information storage unit. The monitoring unit generates function information relate to a system call when the system call is invoked by an application program inside the system. The information collection unit collects system call information including the parameter values of a corresponding function using the generated function information. The information storage unit stores the collected system call information in a nonvolatile memory area of the system.

### FIELD

The present invention relates generally to a black box apparatus and method for supporting the reconfiguration of a smart grid system, and more particularly to a system call-based black box apparatus and method that support the reconfiguration of a smart grid system when a failure occurs.

### BACKGROUND ART

A smart grid system that is designed to provide various services to a user for the purpose of enhancing the efficiency of use of power includes many embedded control systems. Such a smart grid system requires a long time and a lot of effort to determine the cause of an accident because of the complicated operation environment and the characteristic in which many embedded devices are involved when an accident occurs because of a cyber attack or a problem with an embedded device itself.

Generally, since embedded devices that constitute a smart grid system are designed using only limited resources in accordance with the field and purpose of use, they are very sensitive to manufacturing cost. Therefore, in general, embedded devices are fabricated using nonvolatile memory, such as very small-sized Electrically Erasable Programmable Read-Only Memory (EEPROM) or flash ROM, and volatile memory for the execution of a program, such as Random Access Memory (RAM). A compressed root file system configured to include an Operating System (OS) and an environment setting file used to operate a system are stored in the nonvolatile memory, such as EEPROM or flash ROM. Upon booting the system, the compressed root file system in the nonvolatile is decompressed and stored in the partial area of the RAM, thereby operating the system.

Korean Patent No. 10-0933366 discloses a router apparatus having a black box function that is capable of storing data blocks of a specific node or a node group on a network. However, since general embedded devices use volatile memory, all of the data stored in the volatile memory disappears when an abnormal situation occurs in a system as in the case where the system is abruptly rebooted because of a cyber attack or a system error, and thus the general embedded devices are limited in ability to determine the cause of an accident.

### DISCLOSURE

### Technical Problem

The present invention is directed to a black box apparatus and method that provide support in order to rapidly reconfigure an environment based on the time at which an accident occurred when an abnormal situation occurs in a smart grid system because of a cyber attack or a system error.

### Technical Solution

In accordance with an aspect of the present invention, there is provided a black box apparatus for supporting the reconfiguration of a smart grid system, including a monitoring unit configured to generate function information relate to a system call when the system call is invoked by an application program inside the system; an information collection unit configured to collect system call information including the parameter values of a corresponding function using the generated function information; and an information storage unit configured to store the collected system call information in a nonvolatile memory area of the system.

The black box apparatus may further include an information output unit configured to transmit the system call information stored in the nonvolatile memory area to a black box management server in response to a request from the black box management server.

The function information may include one or more of the name of the function and function invocation time.

The system call information may further include the environment setting information of the system at the time at which the system call is invoked.

The nonvolatile memory area in which the system call information is stored may be a form of a circular queue.

The nonvolatile memory may include one or more of EEPROM and flash ROM.

In accordance with an aspect of the present invention, there is provided a method of supporting the reconfiguration of a smart grid system, including generating function information related to a system call when the system call is invoked by an application program inside the system; collecting system call information including parameter values of a corresponding function using the generated function information; and storing the collected system call information in a nonvolatile memory area of the system.

The method may further include transmitting the system call information stored in the nonvolatile memory area to a black box management server in response to a request from the black box management server.

The function information may include one or more of a name of the function and a function invocation time.

The system call information may further include the environment setting information of the system at the time at which the system call is invoked.

The nonvolatile memory area in which the system call information is stored may be a form of a circular queue.

The nonvolatile memory may include one or more of EEPROM and flash ROM.

### Advantageous Effects

The present invention provides support in order to rapidly reconfigure an environment based on the time at which an accident occurs when an abnormal situation occurs in a smart grid system because of a cyber attack or a system error. When an accident occurs, the present invention enables the system to be rapidly reconfigured based on the time at which the accident occurs, thereby being able to analyze the cause of the accident and then recover the system.

### DESCRIPTION OF DRAWINGS

FIG. 1 is a block diagram illustrating a black box system for supporting the reconfiguration of a smart grid system according to an embodiment of the present invention;

FIG. 2 is a detailed block diagram of a black box apparatus according to an embodiment of the present invention;

FIG. 3 is a detailed block diagram of a black box management server according to an embodiment of the present invention;

FIG. 4 is a flowchart illustrating a method for supporting the reconfiguration of a smart grid system according to an embodiment of the present invention that is performed in the black box apparatus; and

FIG. 5 is a flowchart illustrating a method for supporting the reconfiguration of a smart grid system according to an embodiment of the present invention that is performed in the black box management server.

### MODE FOR INVENTION

Details of embodiments are included in the detailed description and the accompanying drawings. The advantages and features of described technologies and methods of achieving them will be apparent from the embodiments that will be described in detail below with reference to the accompanying drawings. Throughout the specification, like reference numerals designate like components.

Embodiments of a black box system, apparatus and method for supporting the reconfiguration of a smart grid system will be described with reference to the accompanying drawings.

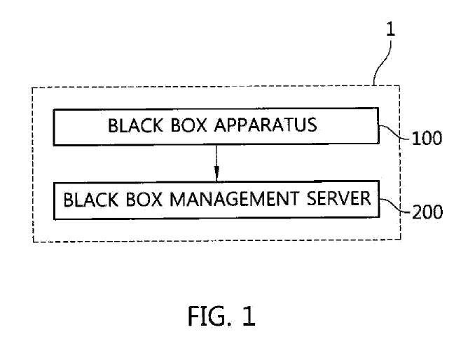

FIG. 1 is a block diagram illustrating a black box system 1 for supporting the reconfiguration of a smart grid system according to an embodiment of the present invention.

Referring to FIG. 1, the black box system 1 for supporting the reconfiguration of a smart grid system according to this embodiment includes a black box apparatus 100 and black box management server 200.

The black box apparatus 100 may be implemented in each of the embedded devices of the smart grid system. The black box apparatus 100 monitors whether an application program of the smart grid system has invoked a system call of the embedded devices, and collects the system call information of a system call-related function if the system call has been invoked. In this case, the black box apparatus 100 generates invoked system call-related function information, and collects system call information using the function information.

The function information may include various types of information required for reconfiguration in the future, such as the name of an invoked system call-related function, function invocation time, etc. Furthermore, the system call information may include generated function information, the parameter values of a corresponding function, and various types of environment setting information.

The black box apparatus 100 may store the collected system call information in a predetermined memory area of the smart grid system. For example, the black box apparatus 100 may store the collected system call information in a nonvolatile memory area, such as electrically erasable and programmable read only memory (EEPROM) or flash read only memory (ROM), so that the smart grid system can be rapidly reconfigured in an abnormal situation, such as in the case where the smart grid system is rebooted because of a cyber attack or an error in the smart grid system.

When an abnormal situation occurs in the smart grid system, partial functionality of the black box apparatus 100 may be stopped under the control of the black box management server 200 to be described later in order to prevent the loss of the stored system call information.

Furthermore, the black box apparatus 100 may transmit the stored system call information to the black box management server 200 in response to a request from the black box management server 200.

When an abnormal situation occurs in the smart grid system, the black box management server 200 controls the black box apparatus 100 so that the partial functionality thereof does not operate.

Furthermore, in order to rapidly reconfigure an environment based on the time at which an accident occurred, the system call information stored in the black box apparatus 100 may be requested, and the system call information may be provided to an administrator when the system call information is transmitted from the black box apparatus 100.

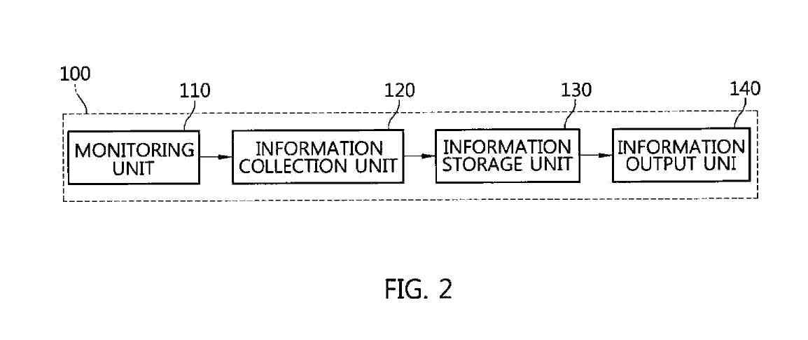

FIG. 2 is a detailed block diagram of the black box apparatus 100 according to an embodiment of the present invention.

The black box apparatus 100 according to this embodiment of the present invention will be described in detail with reference to FIG. 2.

As illustrated in FIG. 2, the black box apparatus 100 may include a monitoring unit 110, an information collection unit 120, an information storage unit 130, and an information output unit 140. In this case, the individual units 110, 120, 130, 140, and 150 that constitute the black box apparatus 100 are divided according to their function. These units 110, 120, 130, 140, and 150 may be implemented in a single hardware device, or may be implemented in two or more hardware devices as needed.

The monitoring unit 110 monitors whether a system call has been invoked by any of various types of application programs of the smart grid system. If, as a result of the monitoring, it is determined that a system call has been invoked by a specific application program, corresponding system call-related function information may be generated. In this case, the function information may include the name of an invoked function, the time at which the function was invoked, and various types of information required for reconfiguration in the event of the occurrence of an abnormal situation, as described above.

Generally, the application programs of the smart grid embedded control system change the state transitions and environment settings of the system using system calls. A general cyber attack installs malware in the system using a system call. Furthermore, serious situations, such as a system error, mostly occur because of the invocation of system calls of application programs.

Accordingly, the monitoring unit 110 monitors an invoked system call in order to store system call information required to rapidly reconfigure the smart grid system based on the time at which an abnormal situation occurred in the smart grid system because of the system call.

When the system call-related function information is generated by the monitoring unit 110, the information collection unit 120 may collect the required system call information using the function information. In this case, the system call information may include the function information of the invoked function, the parameter values of the function, a variety of input values that generate the state transitions of the system, and related environment setting values, as described above.

Once the invoked function-related system call information has been collected, the information storage unit 130 stores the system call information in the predetermined memory area inside the smart grid system. In this case, as described above, the information storage unit 130 may store the system call information in a nonvolatile memory area, such as EEPROM or flash ROM, in order to minimize the loss of stored information even when an abnormal situation occurs in the smart grid system.

In this case, the nonvolatile memory area in which the system call information, such as a variety of types of invoked function-related input values and related environment setting values, are stored may be fabricated in the form of a circular queue. When the space of the circular queue that stores the collected new system call information is insufficient, the information storage unit 130 may store data using a method of overwriting obsolete data.

Since most general embedded devices do not use nonvolatile disks but use parts of RAM areas, that is, volatile memory, instead of disks because of their limited use or purpose of use, all of the data stored in the RAM memory area disappears after rebooting has been performed because the file system overwrites a corresponding RAM memory area like a root file system upon booting the system. As a result, log files that are intended for various terminals in a general Internet environment become inappropriate for investigation into an accident.

However, according to the disclosed this embodiment, the problem of losing related information that occurs because of the characteristics of an embedded device in the general method of storing malware or system accident-related information in volatile memory, such as RAM, can be prevented. Accordingly, an environment at the time at which an accident occurred can be rapidly reconfigured, and thus it is possible to analyze the accurate cause of the accident and to perform recovery.

Meanwhile, the information storage unit 130 may be implemented in the kernel layer of an OS in order to gain access to the nonvolatile memory area in which system call information is stored.

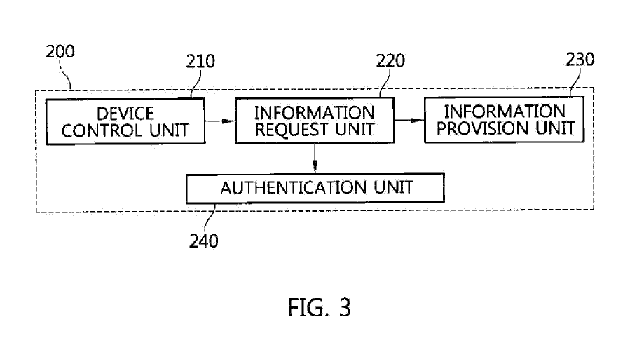

Furthermore, the information storage unit 130 may be implemented to operate under the control of the black box management server 200, as will be described with reference to FIG. 3. For example, when the smart grid system is rebooted because a cyber attack or a system error occurs in the smart grid system, the black box management server 200 stops the information storage unit 130 from automatically operating again, thereby preventing the possibility of data stored at the time at which the accident occurred being lost.

The information output unit 140 may provide the system call information stored in the nonvolatile memory area to the black box management server 200 in response to a request from the black box management server 200. For example, if an abnormal situation or the like occurs in the smart grid system, the information output unit 140 may provide the stored system call information to the administrator who is authorized to access the black box management server 200 through the black box management server 200 in response to a request from the administrator.

FIG. 3 is a detailed block diagram of a black box management server according to an embodiment of the present invention.

Referring to FIG. 3, the black box management server 200 may include a device control unit 210, an information request unit 220, an information provision unit 230, and an authentication unit 240.

The device control unit 210 may control a variety of types of operations of the black box apparatus 100 that has been described with reference to FIG. 2. For example, when an abnormal situation occurs in the smart grid system because of a cyber attack or a system error, the device control unit 210 may stop the function of the black box apparatus 100.

In this case, the device control unit 210 can stop only the function of the information storage unit 130 among the various functions of the black box apparatus 100. This stops the information storage unit 130 from automatically operating again even when the smart grid system is abnormally terminated and then rebooted, and thus prevents new system call information from being stored, thereby preventing system call information stored at the time at which an accident occurred from being changed before the cause of the accident is determined.

However, since this is merely an example, it is possible to automatically control the black box apparatus 100 pursuant to preset or other various policies.

The information request unit 220 requests the system call information stored in the black box apparatus 100. In the event of an accident, the administrator of the smart grid system may request the provision of the system call information in the case of reconfiguring the system or in other necessary cases. When an information provision request is input from the administrator, the information request unit 220 may request the black box apparatus 100 to provide the stored system call, information.

In this case, the information request unit 220 can request the provision of the information from the black box apparatus 100 only if an administrator who requests the provision of the information is an administrator who is authorized to access the system call information. Whether an administrator is an administrator who is authorized to access the system call information may be determined at the step at which authentication is performed by the authentication unit 240 when the former administrator logs in to the black box management server 200. Alternatively, the determination of whether an administrator is an administrator who is authorized to access the system call information may be requested from the authentication unit 240 may be requested at the time at which the former administrator requests information.

When the system call information is transmitted from the black box apparatus 100, the information provision unit 230 outputs the system call information to the display, thereby providing the system call information to the administrator. The administrator may reconfigure an environment based on the time at which an accident occurred using the provided system call information, thereby analyzing the cause of the accident.

The authentication unit 240 may authenticate an administrator who manages the smart grid system through the black box management server 200. In this case, the level of the administrator may be managed according to preset various criteria, and an authority appropriate for the level of the administrator may be assigned. For example, the authority of the administrator may be classified as the authority to control the operation of the black box apparatus 100 or the authority to request the system call information from the black box apparatus 100 and access the black box apparatus 100.

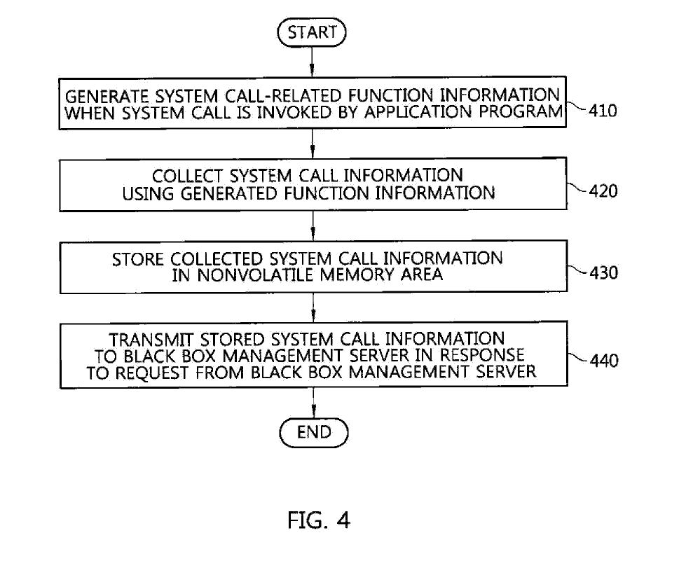

FIG. 4 is a flowchart illustrating a method for supporting the reconfiguration of a smart grid system according to an embodiment of the present invention that is performed in the black box apparatus.

The method for supporting the reconfiguration of a smart grid system illustrated in FIG. 4 may be performed through the black box apparatus 100 according to the embodiment of FIG. 2. Since the method for supporting the reconfiguration of a smart grid system illustrated in FIG. 4 may be appreciated as described above with reference to FIGS. 1 and 2, a brief description will be given in order to avoid redundant descriptions.

First, whether a system call is invoked by any one of the variety of types of application programs of the smart grid system, and, if a system call has been invoked by a specific application program, function information related to the corresponding system call, such as the name of a function and the time at which the system call was invoked, is generated at step 410.

Thereafter, once the invoked system call-related function information is generated, system call information required to rapidly reconfigure an environment based on the time at which the accident occurred in the smart grid system, such as the function information, the parameter values of a corresponding function, a variety of types of input values that generate the state transitions of the system and related environment setting values, is collected using the function information at step 420.

Thereafter, once the invoked function-related system call information has been collected, the system call information is stored in an nonvolatile memory area inside the smart grid system at step 430. In this case, the nonvolatile memory area may be fabricated in the form of a circular queue in order to store new collected system call information using a method of overwriting obsolete data if a space is insufficient to store the new collected system call information.

Thereafter, if a request for the provision of the system call information is received from the black box management server, the system call information stored in the nonvolatile memory area may be transmitted to the black box management server at step 440. The black box management server may request the system call information stored in the black box apparatus if an abnormal situation occurs in the smart grid system.

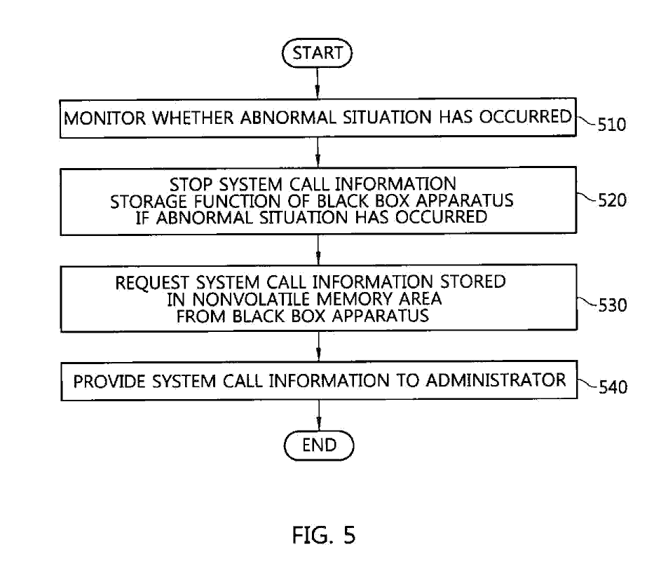

FIG. 5 is a flowchart illustrating a method for supporting the reconfiguration of a smart grid system according to an embodiment of the present invention that is performed in the black box management server 200.

The method for supporting the reconfiguration of a smart grid system illustrated in FIG. 5 may be performed in the black box management server 200 according to the embodiment of FIG. 3.

First, whether an abnormal situation, such as a cyber attack or a system error, has occurred in the smart grid system is monitored at step 510.

Thereafter, if, as a result of the monitoring, an abnormal situation has occurred in the smart grid system, the function of the black box apparatus may be stopped at step 520. In particular, it may be possible to stop only a partial function of storing a system call among various functions of the black box apparatus. This may prevent new system call information from being stored and thus prevent system call information stored at the time at which an accident occurred from being changed before the cause of the accident is determined, even when the smart grid system is abnormally terminated and then rebooted.

Thereafter, the system call information stored in the black box apparatus may be requested at step 530.

In this case, an administrator can request the provision of the information from the black box apparatus only if the administrator who requests the provision of the information system is an administrator who is authorized to access the system call information. The step of determining whether an administrator is an administrator who is authorized to access the system call information when the administrator requests information may be included.

The step of determining whether an administrator is an administrator who is authorized to access the system call information may be configured to determine the appropriate authority of each administrator based on the level of the authority that is set for the each administrator and to allow the administrator to exercise only the appropriate authority.

Thereafter, when the system call information is transmitted from the black box apparatus, the system call information is output through the display, thereby providing the system call information to the administrator at step 540. The administrator may reconfigure an environment based on the time at which the accident occurred using the provided system call information, and may then analyze the cause of the accident.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A black box apparatus for supporting reconfiguration of a smart grid system, comprising:
a monitoring unit configured to generate function information relate to a system call when the system call is invoked by an application program inside the system;
an information collection unit configured to collect system call information including parameter values of a corresponding function using the generated function information; and
an information storage unit configured to store the collected system call information in a nonvolatile memory area of the system.

2. The black box apparatus of claim 1, further comprising an information output unit configured to transmit the system call information stored in the nonvolatile memory area to a black box management server in response to a request from the black box management server.

3. The black box apparatus of claim 1, wherein the function information includes one or more of a name of the function and a function invocation time.

4. The black box apparatus of claim 1, wherein the system call information further includes environment setting information of the system at a time at which the system call is invoked.

5. The black box apparatus of claim 1, wherein the nonvolatile memory area in which the system call information is stored is a form of a circular queue.

6. The black box apparatus of claim 1, wherein the nonvolatile memory includes one or more of Electrically Erasable Programmable Read-Only Memory (EEPROM) and flash Read-Only Memory (ROM).

7. A method of supporting reconfiguration of a smart grid system, comprising:
generating function information related to a system call when the system call is invoked by an application program inside the system;
collecting system call information including parameter values of a corresponding function using the generated function information; and
storing the collected system call information in a nonvolatile memory area of the system.

8. The method of claim 7, further comprising transmitting the system call information stored in the nonvolatile memory area to a black box management server in response to a request from the black box management server.

9. The method of claim 7, wherein the function information includes one or more of a name of the function and a function invocation time.

10. The method of claim 7, wherein the system call information further includes environment setting information of the system at a time at which the system call is invoked.

11. The method of claim 7, wherein the nonvolatile memory area in which the system call information is stored is a form of a circular queue.

12. The method of claim 7, wherein the nonvolatile memory includes one or more of EEPROM and flash ROM.
